(19) United States
(12) Patent Application Publication
(10) Pub. No.: US 2013/0218851 A1
(43) Pub. Date: Aug. 22, 2013

(54) STORAGE SYSTEM, DATA MANAGEMENT DEVICE, METHOD AND PROGRAM

(71) Applicant: Satoshi Yamakawa, Tokyo (JP)

(72) Inventor: Satoshi Yamakawa, Tokyo (JP)

(73) Assignee: NEC CORPORATION, Minato-ku, Tokyo (JP)

(21) Appl. No.: 13/879,662

(22) PCT Filed: Oct. 3, 2011
(86) PCT No.: PCT/JP2011/005574

§ 371 Date: Apr. 16, 2013

(30) Foreign Application Priority Data
Oct. 19, 2010 (JP) 2010-234807

(51) Int. Cl. G06F 17/30

(52) U.S. Cl. CPC G06F 17/30156
USPC 707/692

(57) ABSTRACT

A storage system is characterized in that the storage system includes duplication-determination-unit determining means for determining a duplication determination unit, which is a unit to be used in determining duplications of data, on the basis of a duplication generation rate computed for each of a plurality of data division units obtained as a result of division of data stored in a storage device, and duplication eliminating means for carrying out processing to eliminate duplications of the data stored in the storage device on the basis of the duplication determination unit determined by the duplication-determination-unit determining means.

### TECHNICAL FIELD

The present invention relates to a storage system as well as a data management device, a data management method and a data management program which are used in the system.

### BACKGROUND ART

In a storage device for concentratively storing data generated by a plurality of computing terminals, there may be adopted a technique for reducing the physical recording capacity of the storage device. This technique is referred to as a deduplication technique. In accordance with this technique for reducing the physical recording capacity of a physical storage medium such as a hard disk drive, at a stage of storing data in the physical storage medium, the data is examined in order to determine whether or not the data is a duplicate of data already stored in the medium. If the data to be stored in the physical storage medium is a duplicate of the data already stored in the medium, the data to be stored is not again stored in the medium. Instead, only information on a pointer pointing to the data already stored in the physical storage medium is recorded.

In accordance with this duplication technique, normally, duplication of already stored data is determined in file units or physical data block units fixedly allocated in an operation to store data into a storage medium in a file system. In this duplication determination, pieces of digest data having a small size are compared with each other in order to determine whether files or data blocks of the pieces of digest data have the same byte array. In this case, the digest data is data generated by making use of a hash function to have a size of several tens to several hundreds of bits. Examples of the hash function are SHA1 and MD5 which are used in digital certification and the like.

By adopting the duplication determination technique making use of digest data as described above, it is possible to reduce the processing cost of the duplication determination carried out on the storage device. In particular, also in data storing processing anticipating execution of high-speed I/O processing, by carrying out the duplication determination at the same time as the I/O processing, it is possible to obtain also an effect of preventing the I/O processing performance from deteriorating.

A duplication eliminating storage system is a system making use of such digest data as means for determining duplication of data. The number of applications of such duplication eliminating storage systems serving as one of means for reducing the data storage cost is increasing. Particularly, in a computing environment anticipating a large number of files or data blocks each composed of the same byte array, the duplication eliminating storage system is applied to a storage device intended to serve as a device for storing backup data and a storage device intended to serve as a device for storing image data of system portions of a plurality of virtual operating systems.

In addition, as a related technology, documents such as Patent Literature 1 describe a method for eliminating duplication of data having an XML format when handling such data.

### CITATION LIST

### Patent Literature

Patent Literature 1

JP-2003-323428-A

### SUMMARY OF INVENTION

### Technical Problem

In an ordinary duplication eliminating storage system, the duplication determination unit used in determination of duplication of data to be stored is a uniform unit. That is to say, the duplication determination can be carried out only for each uniform data unit fixedly determined in advance. Examples of such a data unit are a file unit and a data block unit.

In addition, instead of carrying out the duplication determination by adopting a fixed unit such as the file or block unit described above, it is possible to perform duplication determination by adopting another technology. According to this technology, efforts are made for example to extract more potentially duplicated data. Typically, the efforts are made by changing a method for dividing data used in the duplication determination in accordance with the type of the data format and/or a specific file.

By adopting a variety of duplication determination units in the duplication eliminating storage device as described above, it is possible to detect data, which has a high probability of being potentially duplicated, without leakages. However, duplication determination processing making use of a data unit having a smaller size or adoption of a more complicated data division method undesirably causes the processing performance to deteriorate at a data storing time and a data reading-out time due to execution of the duplication determination processing.

That is to say, no matter which duplication determination unit is used, it is impossible to reduce the data storage cost by eliminating duplications if the environment in which the data to be actually stored is used does not match the duplication determination unit.

As described above, in the duplication determination processing carried out in uniform duplication determination units and the duplication determination processing carried out in duplication determination units changed in accordance with the type of the data format and/or the file, unnecessary processing for unduplicated data is repeated if a duplication generation trend based on the environment in which the data is used does not match the duplication determination unit. Thus, there are raised a problem that it is not possible to obtain the effect of reducing the data storage cost and a problem that the storage device is merely an inefficient device which has poor data write and data read-out performances.

By adopting the method described in Patent Literature 1, duplications of data can be eliminated with a high degree of efficiency in duplication elimination processing. However, the problems described above are not addressed.

For example, it is assumed that the duplication elimination rate generally increases in the following order: file<block<object. With this assumption, merely on the basis of determination of the magnitudes of the different duplication elimination rates, the object duplication elimination rate is undesirably selected for all cases. From the division-processing load point of view, on the other hand, the order of file<block<object is obvious. Thus, if the difference in duplication elimination rate between the division methods is large, an effect commensurate with the processing load cannot be obtained.

It is therefore an object of the present invention to provide a data storage system, a data management device, a data management method and a data management program which allow the data storage capacity to be reduced to a capacity commensurate with the cost of managing duplication eliminations.

### Solution to Problem

A storage system according to the present invention is characterized in that the storage system includes:

duplication-determination-unit determining means for determining a duplication determination unit, which is a unit to be used in determining duplications of data, on the basis of a duplication generation rate computed for each of a plurality of data division units obtained as a result of division of data stored in a storage device; and

duplication eliminating means for carrying out processing to eliminate duplications of the data stored in the storage device on the basis of the duplication determination unit determined by the duplication-determination-unit determining means.

A storage system according to the present invention includes at least one file storage device and a duplication eliminating storage device. The storage system is characterized in that the storage system includes:

data-division-unit determining means for selectively determining one of a plurality of data division units by computing a duplication generation rate for each of the data division units and by comparing the duplication generation rates with each other when determining a duplication generation trend of data stored in the file storage device by making use of the data division units; and

data relocation means for relocating data from the file storage device to the duplication eliminating storage device in aforementioned data division units determined by the data-division-unit determining means.

A data management device according to the present invention is characterized in that the data management device includes:

duplication-determination-unit determining means for determining a duplication determination unit, which is a unit to be used in determining duplications of data, on the basis of a duplication generation rate computed for each of a plurality of data division units obtained as a result of division of data stored in a storage device; and

duplication eliminating means for carrying out processing to eliminate duplications of the data stored in the storage device on the basis of the duplication determination unit determined by the duplication-determination-unit determining means.

A data management method according to the present invention is characterized in that the data management method includes the steps of:

determining a duplication determination unit, which is a unit to be used in determining duplications of data, on the basis of a duplication generation rate computed for each of a plurality of data division units obtained as a result of division of data stored in a storage device; and

carrying out processing to eliminate duplications of the data stored in the storage device on the basis of the determined duplication determination unit.

A data management program according to the present invention is characterized in that the data management program is executed by a computer to carry out:

duplication-determination-unit determination processing of determining a duplication determination unit, which is a unit to be used in determining duplications of data, on the basis of a duplication generation rate computed for each of a plurality of data division units obtained as a result of division of data stored in a storage device; and

duplication elimination processing of eliminating duplications of the data stored in the storage device on the basis of the determined duplication determination unit.

### Advantageous Effects of the Invention

In accordance with the present invention, it is possible to reduce the data storage capacity to a capacity commensurate with the cost of managing duplication eliminations.

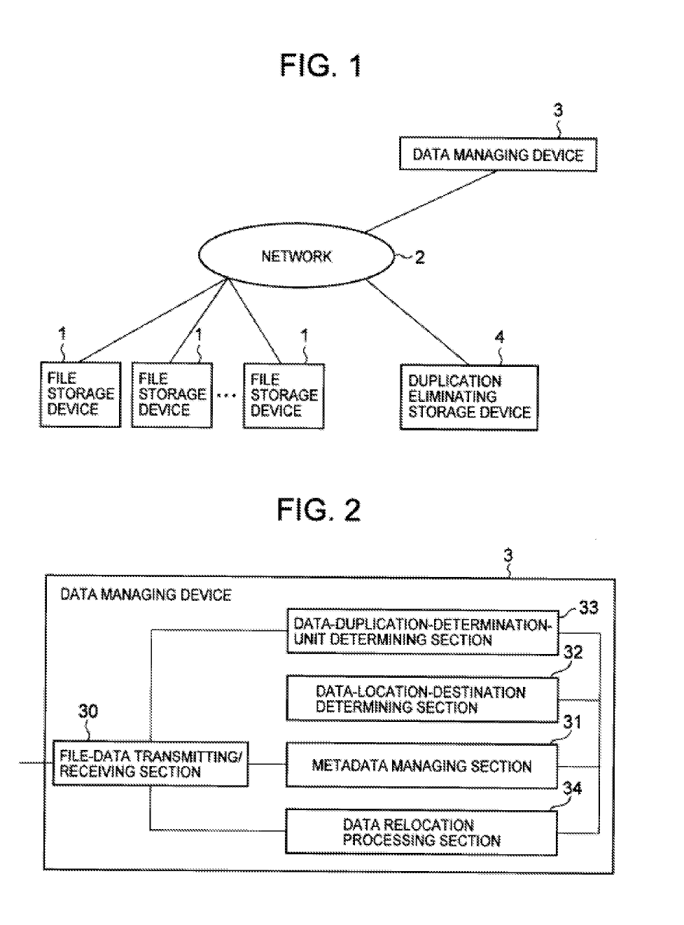

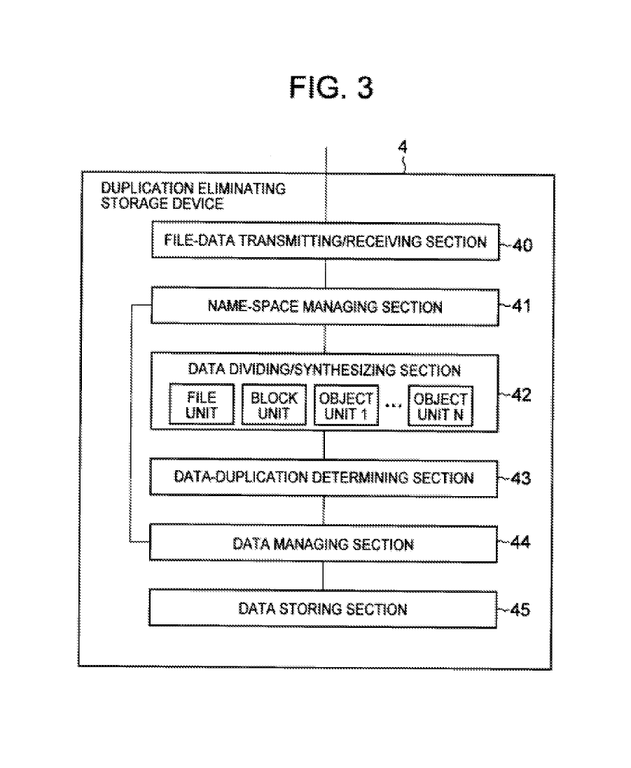

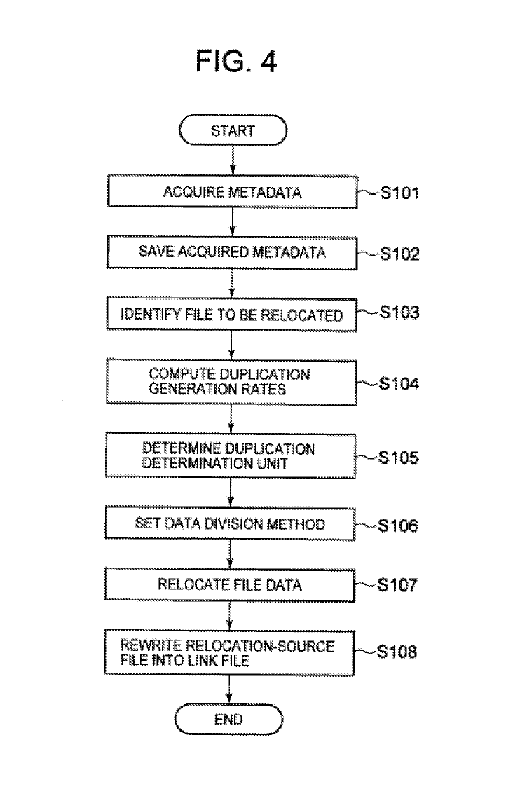

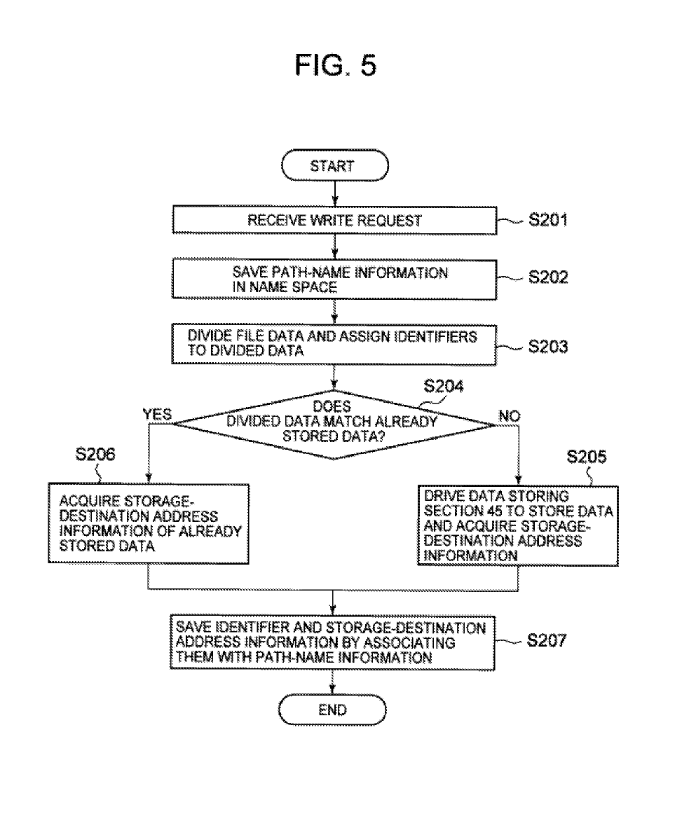

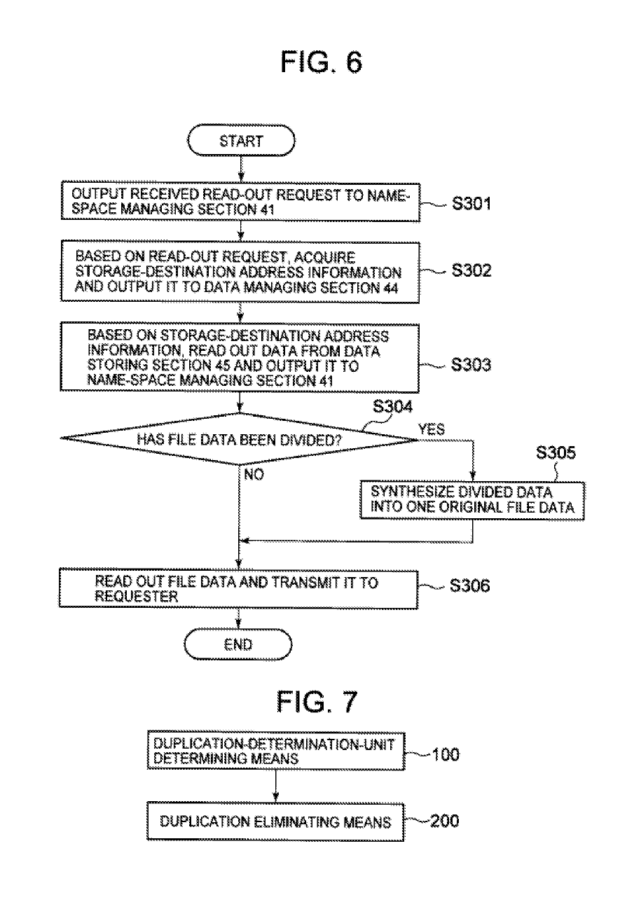

### BRIEF DESCRIPTION OF DRAWINGS

[FIG. 1] It depicts a block diagram showing a typical configuration of a storage system according to the present invention.

[FIG. 2] It depicts a block diagram showing a typical functional configuration of a data managing device 3.

[FIG. 3] It depicts a block diagram showing a typical functional configuration of a duplication eliminating storage device 4.

[FIG. 4] It depicts a flowchart representing typical data relocation processing.

[FIG. 5] It depicts a flowchart representing typical data storing processing in the duplication eliminating storage device 4.

[FIG. 6] It depicts a flowchart representing typical processing to read out file data stored in the duplication eliminating storage device 4.

[FIG. 7] It depicts a block diagram showing a typical minimum configuration of a storage system.

### DESCRIPTION OF EMBODIMENTS

Exemplary embodiments of the present invention are described by referring to diagrams as follows. FIG. 1 is a block diagram depicting a typical configuration of a storage system according to the present invention.

The storage system according to the present invention includes one or more file storage device 1, a data managing device 3 and a duplication eliminating storage device 4. The file storage device 1 are connected to the data managing device 3 and the duplication eliminating storage device 4 by a network 2 such as the Internet and a LAN.

In the storage system according to this exemplary embodiment, the file storage device 1, the data managing device 3 and the duplication eliminating storage device 4 are different from each other. It is to be noted, however, that configurations of the storage system are by no means limited to this exemplary embodiment. For example, the storage system can be implemented by integrating the data managing device 3 and the duplication eliminating storage device 4 into a single device, by integrating the file storage device 1 and the duplication eliminating storage device 4 into a single device or by integrating the file storage device 1, the data managing device 3 and the duplication eliminating storage device 4 into a single device.

The file storage device 1 is used for storing file data (also referred to hereafter simply as a file). The file storage device 1 is provided with a function to carry out file access processing on file data stored therein on the basis of a request received from an external device through the network 2 as a request for file access processing such as processing to newly create a file, processing to delete a file, processing to read out a file and processing to write a file. In addition, the file storage device 1 is provided with a function to return results of the file access processing carried out thereby to the external device which has made the request for the file access processing. To put it concretely, the file storage device 1 is implemented as a storage device such as an optical-disk device or a magnetic-disk device. In addition, the file storage device 1 is implemented typically as a database server.

Next, the data managing device 3 is explained as follows. FIG. 2 is a block diagram depicting a typical functional configuration of the data managing device 3.

As shown in FIG. 2, the data managing device 3 includes a file-data transmitting/receiving section 30, a metadata managing section 31, a data-location-destination determining section 32, a data-duplication-determination-unit determining section 33 and a data relocation processing section 34. To put it concretely, the data managing device 3 is implemented as an information processing device such as a personal computer which operates in accordance with programs.

The file-data transmitting/receiving section 30 is an input/output interface for exchanging file data between the data managing device 3 and an external device. The file-data transmitting/receiving section 30 is provided with client functions conforming to an industrial standard protocol such as the NFS (Network File System) or the CIFS (Common Internet File System). To put it concretely, the file-data transmitting/receiving section 30 is implemented by a CPU employed in an information processing device to serve as a CPU operating in accordance with a program and a network interface section.

The metadata managing section 31 is provided with a function to acquire a file name and time information from metadata for each predetermined period of time and store the file name and the time information in a storage section (not shown in the figure). The metadata is data attached to a file group stored in the file storage device 1. The time information is a last update time, a last access time or a last metadata updating time. As a method for acquiring these pieces of information, for example, the metadata managing section 31 may make an access to the file storage device 1 for each of the predetermined periods of time in order to extract the information or the file storage device 1 may transmit the information to the metadata managing section 31 for each of the predetermined periods of time.

In addition, the metadata managing section 31 is provided with a function to store data in the storage section by associating the data with metadata. The data is data indicating whether or not processing to relocate file data from the file storage device 1 to the duplication eliminating storage device 4 has been carried out. In the following description, this data stored by the metadata managing section 31 in the storage section is also referred to as data (or metadata) saved by the metadata managing section 31. To put it concretely, the metadata managing section 31 is implemented by a CPU employed in an information processing device to serve as a CPU operating in accordance with a program.

The data-location-destination determining section 32 is provided with a function to determine file data (also referred to hereafter as a relocation-object file) to be relocated from the file storage device 1 to the duplication eliminating storage device 4 on the basis of a predetermined rule by referring to a most recent metadata group saved by the metadata managing section 31. It is to be noted that the predetermined rule is typically a rule created by a data manager and stored in the storage section of the data managing device 3. To put it concretely, the data-location-destination determining section 32 is implemented by a CPU employed in an information processing device to serve as a CPU operating in accordance with a program.

The data-duplication-determination-unit determining section 33 is provided with a function to acquire file data from the file storage device 1 by referring to a most recent metadata group saved by the metadata managing section 31. In addition, the data-duplication-determination-unit determining section 33 is also provided with functions to divide data for a plurality of data division units, select one of the data division units to serve as a unit on which duplication elimination can be carried out with the highest degree of efficiency, take the selected unit as a duplication determination unit and determine a data division method based on the duplication determination unit. To put it concretely, the data-duplication-determination-unit determining section 33 is implemented by a CPU employed in an information processing device to serve as a CPU operating in accordance with a program.

The data relocation processing section 34 is provided with a function to relocate a relocation-object file determined by the data-location-destination determining section 32 from the file storage device 1 to the duplication eliminating storage device 4 on the basis of the data division method determined by the data-duplication-determination-unit determining section 33. To put it concretely, the relocation of a relocation-object file is an operation to move the file from a storage area in the file storage device 1 and store the file into a storage area in the duplication eliminating storage device 4. To put it concretely, the data relocation processing section 34 is implemented by a CPU employed in an information processing device to serve as a CPU operating in accordance with a program.

Next, the duplication eliminating storage device 4 is explained. FIG. 3 is a block diagram depicting a typical functional configuration of the duplication eliminating storage device 4.

As shown in FIG. 3, the duplication eliminating storage device 4 includes a file-data transmitting/receiving section 40, a name-space managing section 41, a data dividing/synthesizing section 42, a data-duplication determining section 43, a data managing section 44 and a data storing section 45.

The file-data transmitting/receiving section 40 is an input/output interface for exchanging file data between the duplication eliminating storage device 4 and an external device. The file-data transmitting/receiving section 40 is provided with server functions conforming to an industrial standard protocol such as the NFS or the CIFS.

The name-space managing section 41 is provided with a function to manage a directory structure as well as directory and file names and a function to disclose a plurality of independent directory trees to external device. To put it concretely, the function to disclose directory trees is a function to transmit information on the directory trees to an external terminal by way of the network 2 at a request made by the external terminal.

The data dividing/synthesizing section 42 is provided with a function to divide file data, which is to be stored in the data storing section 45 in accordance with management carried out by the name-space managing section 41, into block units or object units. In addition, the data dividing/synthesizing section 42 is also provided with a function to synthesize post-division data stored in the data storing section 45 in order to generate original file data.

The data-duplication determining section 43 is provided with a function to determine whether or not data divided by the data dividing/synthesizing section 42 into post-division data to be stored is a duplicate of data already stored.

The data managing section 44 is provided with a function to manage information on relations between data divided by the data dividing/synthesizing section 42 and original file data (or pre-division file data). In addition, the data managing section 44 is also provided with a function to manage information on storage start addresses of data to be stored in the data storing section 45. To put it concretely, the function to manage information on storage start addresses includes a function to store the information by associating the information with other information and update the information on an as-needed basis.

The data storing section 45 is used for storing data specified by the data managing section 44. To put it concretely, the data storing section 45 is implemented as a storage device configured to include one or more HDDs (Hard Disk Drives).

In the storage system according to the exemplary embodiment, the data managing device 3 selects data with a low utilization frequency among file data stored in the file storage device 1 and determines a data division unit on which duplication detection can be carried out with the highest degree of efficiency. Then, the data managing device 3 stores the data with a low utilization frequency in the duplication eliminating storage device 4 in optimum duplication detection units (data division units). The storage system according to the exemplary embodiment is intended to serve as a storage system capable of reducing the whole data storage capacity of the storage system by carrying out these pieces of processing.

Next, operations carried out by the storage system are explained as follows. Operations explained below as the operations carried out by the storage system according to the exemplary embodiment are three kinds of processing. The three kinds of processing is processing to relocate data from the file storage device 1 to the duplication eliminating storage device 4, processing to store data in the duplication eliminating storage device 4 and processing to read out file data stored in the duplication eliminating storage device 4. It is to be noted that, in this exemplary embodiment, the processing to relocate data from the file storage device 1 to the duplication eliminating storage device 4 and the processing to store data in the duplication eliminating storage device 4 are also referred to as processing to eliminate duplications of data stored in the file storage device 1.

### Data Relocation Processing

First of all, by referring to FIG. 4, the following description explains the processing to relocate file data from the file storage device 1 to the duplication eliminating storage device 4. FIG. 4 depicts a flowchart representing an example of the data relocation processing.

In this case, it is assumed that the file systems of a plurality of file storage device 1 are disclosed to the public. At a step S101, the metadata managing section 31 employed in the data managing device 3 acquires metadata of all files stored in the file systems from the file storage device 1 by way of the file-data transmitting/receiving section 30 for all disclosed file systems.

It is to be noted that the metadata includes time information and path-name information. The time information is a last file accessing time, a last update time or a last metadata updating time. In addition, the metadata also includes a flag indicating whether or not file data is file data already relocated to the duplication eliminating storage device 4.

Then, at the next step S102, the metadata managing section 31 stores the metadata acquired from the file storage device 1 in a storage section for each file system disclosed to the public in order to save the metadata in the storage section. In this case, the metadata managing section 31 is assumed to also save the flag of file data in the storage section by associating the flag with the metadata. As described above, the flag is a flag indicating whether or not file data is file data already relocated to the duplication eliminating storage device 4. It is to be noted that the operation to acquire metadata is assumed to be an operation carried out by typically a storage system manager for every period determined in advance.

After the operation to acquire metadata has been completed, on the basis of the metadata saved by the metadata managing section 31 in the storage section, at the next step S103, the data-location-destination determining section 32 determines a relocation-object file to be relocated to the duplication eliminating storage device 4.

To put it concretely, the data-location-destination determining section 32 refers to the metadata saved by the metadata managing section 31 in the storage section and, on the basis of flags attached to the metadata, identifies files not relocated yet to the duplication eliminating storage device 4. Then, on the basis of time information which is a last access time, a last update time or a last metadata updating time, the data-location-destination determining section 32 selects a file from the identified files and takes the selected file as a relocation-object file. In this case, the file taken as the relocation-object file is a file not experiencing accesses, updating operations and metadata updating operations during a period determined in advance.

It is to be noted that, for example, in the second operation to acquire metadata from the file storage device 1 and such subsequent operations, the metadata managing section 31 takes only specific files as a metadata-acquisition object. In this case, the specific files are a file not determined by the data-location-destination determining section 32 as a relocation object and a file created during or after the preceding operation to acquire metadata.

In addition, after the operation to acquire metadata, the metadata managing section 31 is assumed to determine whether or not the time information which is a last access time, a last update time or a last metadata updating time has been updated since the preceding operation to acquire metadata. It is also assumed that, on the basis of the result of the determination, the metadata managing section 31 saves a flag for a file in the storage section by associating the flag with the metadata. The saved flag is a flag indicating that the file is a newly created file or a file having updated time information.

After the operation carried out by the metadata managing section 31 to acquire metadata has been completed, on the basis of most recent metadata saved by the metadata managing section 31, the data-duplication-determination-unit determining section 33 acquires file data from the file storage device 1 through the file-data transmitting/receiving section 30 for every file system serving as a management object.

Then, at the next step S104, the data-duplication-determination-unit determining section 33 divides data by making use of three units and computes the duplication generation rate of the data in accordance with a data division method for the three units for every file system of the file storage device 1. In this case, the three units are a file unit, a block unit and an object unit respectively. It is to be noted that the data-duplication-determination-unit determining section 33 may compute the duplication generation rate typically by making use of the following equation.

Data duplication generation rate=(The total number of pieces of actually duplicated data)/(The total number of pieces of duplication evaluation data)

Then, at the next step S105, the data-duplication-determination-unit determining section 33 determines the duplication determination unit on the basis of the computed duplication generation rates.

To put it concretely, the data-duplication-determination-unit determining section 33 determines whether or not the condition described as follows is met. The condition requires that the following relation hold true: The duplication generation rate for the file unit<The duplication generation rate for the block unit. In addition, the condition also requires that N be not smaller than a threshold value determined in advance. In this relation, symbol N is the value of the ratio (The duplication generation rate for the file unit)/(The duplication generation rate for the block unit).

Then, if the condition described above is met, the data-duplication-determination-unit determining section 33 determines that an operation to divide a file into block units and store the block units in a memory by eliminating duplications of the block units is most efficient. That is to say, the data-duplication-determination-unit determining section 33 takes the block unit as a duplication determination unit.

If the condition described above is not met, on the other hand, the data-duplication-determination-unit determining section 33 determines that an operation to divide data into file units and store the file units in a memory by eliminating duplications of the file units is most efficient. That is to say, the data-duplication-determination-unit determining section 33 takes the file unit as a duplication determination unit.

By the same token, the data-duplication-determination-unit determining section 33 determines whether or not the condition described as follows is met. The condition requires that the following relation hold true: The duplication generation rate for the block unit<The duplication generation rate for the object unit. In addition, the condition also requires that N be not smaller than a threshold value determined in advance. In this relation, symbol N is the value of the ratio (The duplication generation rate for the block unit)/(The duplication generation rate for the object unit).

Then, if the condition described above is met, the data-duplication-determination-unit determining section 33 determines that an operation to divide a file into object units and store the object units in a memory by eliminating duplications of the object units is most efficient. That is to say, the data-duplication-determination-unit determining section 33 takes the object unit as a duplication determination unit.

If the condition described above is not met, on the other hand, the data-duplication-determination-unit determining section 33 determines that an operation to divide a file into block units and store the block units in a memory by eliminating duplications of the block units is most efficient. That is to say, the data-duplication-determination-unit determining section 33 takes the block unit as a duplication determination unit.

It is to be noted that an operation to determine whether or not data is duplicated can be carried out by adoption of typically a method described as follows. For example, the data-duplication-determination-unit determining section 33 computes digest data from data by making use of a hash function and manages the computed digest data along with path names in a hash table. Then, the data-duplication-determination-unit determining section 33 determines whether or not data is duplicated on the basis of a result of determination as to whether or not a newly computed digest value for the data matches an already computed digest value.

As described above, the data-duplication-determination-unit determining section 33 determines a duplication determination unit serving as a unit for which the duplication elimination efficiency is highest in all file systems. In addition to a duplication elimination rate, the duplication elimination efficiency can be said also to reflect the management cost of the duplication elimination taking the processing load and the processing effect into consideration.

Then, at the next step S106, the data-duplication-determination-unit determining section 33 determines a data division method based on the duplication elimination unit and sets the determined data division method as an optimum data division method in the file systems managed by the metadata managing section 31.

As described above, in this exemplary embodiment, a data division method is selected among different data division methods on the basis of the magnitudes of differences between duplication elimination rates. Thus, in comparison with a previous technology for determining a data division method on the basis of duplication elimination rates of a plurality of data division methods, it is possible to select a data division method capable of exhibiting an effect commensurate with the processing load.

It is to be noted that the operations of the steps S104 to S106 are assumed to be carried out only in conjunction with the operation carried out at the step S103 to determine a file serving as the first relocation object. As described above, the data-duplication-determination-unit determining section 33 carries out the operations of the steps S104 to S106 in order to determine a data division method (or a duplication determination unit) providing the highest duplication elimination efficiency. On the other hand, the operation of the step S103 is carried out by the data-location-destination determining section 32 to determine a file serving as the first relocation object.

In addition, for example, the data-duplication-determination-unit determining section 33 carries out the operation to determine a data division method for each period determined in advance. If the newly determined data division method is different from the already set data division method, the newly determined data division method can be adopted as a newly set optimum data division method. In addition, for example, the storage system can be provided with data re-storing means (shown in none of the figures) for re-storing already stored data by making use of a newly set optimum duplication determination unit (or the newly set optimum data division method).

Then, at the next step S107, after the data-location-destination determining section 32 has determined a file serving as a relocation object and the data-duplication-determination-unit determining section 33 has determined the optimum duplication determination unit (or the optimum data division method), the data relocation processing section 34 reads out the file serving as a relocation object from the file storage device 1 and stores the file into the duplication eliminating storage device 4 on the basis of the data division method.

The duplication eliminating storage device 4 is provided with a special-purpose file system serving as a data storage destination for every data division method, that is, for each of the file unit, the block unit and the object unit. Then, the data relocation processing section 34 selects a file system for the optimum data division method, which has been determined by the data-duplication-determination-unit determining section 33, to serve as a data storage destination in the duplication eliminating storage device 4.

It is to be noted that, to put it concretely, the data-location-destination determining section 32 transmits a request for a write operation along with the file serving as a relocation object to the duplication eliminating storage device 4 and the duplication eliminating storage device 4 carries out the write operation in accordance with the request. Details of this write operation will be described later.

Then, at the next step S108, in an operation to write the file data into the duplication eliminating storage device 4, the data relocation processing section 34 makes use of the original file read out from the file storage device 1 to rewrite a link file serving as a link to a file stored in the duplication eliminating storage device 4. To put it concretely, the data-location-destination determining section 32 transmits a rewrite request to the file storage device 1 and the file storage device 1 carries out rewrite processing in accordance with the rewrite request. Later on, the data relocation processing section 34 ends the processing to relocate the file.

It is to be noted that the file storage device 1 is assumed to create a link file such as a symbolic file. In addition, the created link file is assumed to include information on the address of a relocation destination included in the duplication eliminating storage device 4 to serve as the relocation destination of a file relocated from the file storage device 1.

When the data relocation processing section 34 completes the processing to relocate all files each serving as a relocation object as described above, the data managing device 3 ends the data relocation processing.

### Data Storing Processing in the Duplication Eliminating Storage Device 4

Next, data storing processing carried out by the duplication eliminating storage device 4 is explained by referring to a flowchart shown in FIG. 5 as follows. FIG. 5 is a flowchart representing typical data storing processing carried out by the duplication eliminating storage device 4.

The duplication eliminating storage device 4 according to this exemplary embodiment is provided with a plurality of special-purpose name spaces for a plurality of duplication determination units (or a plurality of data division methods) which can be determined by the data managing device 3. In addition, these name spaces are assumed to be disclosed to the public through the file-data transmitting/receiving section 40. Thus, at least three name spaces are assumed to be disclosed to the public. The three name spaces disclosed to the public are name spaces for the file unit, the block unit and the object unit respectively. It is to be noted that a plurality of name spaces each corresponding to the data division method for the object unit are assumed to be allowed to exist for each type of file format.

These name spaces are managed by the name-space managing section 41. In addition, each of the name spaces is assumed to be associated with the data division method that can be implemented by the data dividing/synthesizing section 42.

At a stage prior to the data storing processing carried out by the duplication eliminating storage device 4, the data relocation processing section 34 employed in the data managing device 3 extracts file data stored in the file storage device 1 as a relocation object. Then, the data relocation processing section 34 selects a name space from the name spaces, which are provided for the duplication eliminating storage device 4, to serve as a storage destination of the file data. The selected name space is a name space associated with a data division method matching the data division method determined by the data-duplication-determination-unit determining section 33.

Then, the data relocation processing section 34 employed in the data managing device 3 transmits the extracted file data along with a write request including information on the selected storage destination to the duplication eliminating storage device 4.

After the processing described above has been carried out by the data managing device 3, at a step S201 of the flowchart shown in FIG. 4, the file-data transmitting/receiving section 40 employed in the duplication eliminating storage device 4 receives the file data as well as the write request. Then, on the basis of the file data and the write request which have been received by the file-data transmitting/receiving section 40, the file-data transmitting/receiving section 40 outputs the file data to the name-space managing section 41 for managing name spaces each serving as a storage destination of received data.

Then, at the next step S202, the name-space managing section 41 stores path-name information showing a path name in the name space including a file name in a storage section in order to save the information. Later on, the name-space managing section 41 outputs the file data to the data dividing/synthesizing section 42.

Then, at the next step S203, the data dividing/synthesizing section 42 divides the file data in accordance with a data division method associated with the name space of the storage destination into pieces of partial data and assigns a unique identifier to each piece of partial data. The identifier unique to the piece of partial data in the duplication eliminating storage device 4 is an identifier used for uniquely identifying the piece of partial data. Afterwards, the data dividing/synthesizing section 42 outputs the pieces of partial data to the data-duplication determining section 43.

Then, at the next step S204, the data-duplication determining section 43 computes a digest value from the data by making use of a hash function and determines whether or not the computed digest value matches the digest value of already stored data. It is to be noted that a list of digest values of already stored data is assumed to be recorded in the data managing section 44 in the format of a table. In the following description, the table is referred to as an address management table. In order to determine whether or not the computed digest value matches the digest value of already stored data, the data-duplication determining section 43 compares the computed digest value with the digest values already recorded in the address management table.

If the data-duplication determining section 43 determines that the computed digest value does not match the digest values already registered in the address management table, the data-duplication determining section 43 outputs the computed digest value and the data represented by the digest value to the data managing section 44 along with the identifier assigned by the data dividing/synthesizing section 42 to the data.

Then, at the next step S205, the data managing section 44 registers the digest value in the address management table and stores the data in the data storing section 45. In addition, the data managing section 44 also acquires information on the address of the storage destination in the data storing section 45.

Later on, the data managing section 44 outputs the identifier and the information on the address of the storage destination to the data-duplication determining section 43. In addition, the data managing section 44 registers the information on the address of the storage destination in the address management table by associating the information with the digest value registered at the step S205.

The identifier and the information on the address of the storage destination are output from the data-duplication determining section 43 to the name-space managing section 41 by way of the data dividing/synthesizing section 42. That is to say, the data-duplication determining section 43 outputs the identifier and the information on the address of the storage destination to the name-space managing section 41.

If the determination result produced at the step S204 indicates that the computed digest value matches the digest values of already stored data, on the other hand, the flow of the processing goes on to a step S206 at which the data-duplication determining section 43 acquires storage-destination address information associated with the matching digest value registered in the address management table managed by the data managing section 44.

By the same token, the identifier and the information on the address of the storage destination are output from the data-duplication determining section 43 to the name-space managing section 41 by way of the data dividing/synthesizing section 42. That is to say, the data-duplication determining section 43 outputs the identifier and the information on the address of the storage destination to the name-space managing section 41.

Then, at the next step S207, the name-space managing section 41 manages the identifier and the storage-destination address information, which have been output at the step S205 or S206, by associating the identifier and the information on the address of the storage destination with path-name information in a name space including the file name. That is to say, the name-space managing section 41 stores the identifier and the information on the address of the storage destination in a storage section by associating the identifier and the information on the address of the storage destination with the path-name information saved at the step S202. It is to be noted that the name-space managing section 41 is assumed to manage these pieces of information by recording the information in a table referred to as a name-space management table.

When the processing carried out by the data-duplication determining section 43 at the steps S204 to S207 on all data obtained as a result of the data division performed by the data dividing/synthesizing section 42 is ended, the name-space managing section 41 determines that the processing to store the file data in a storage section is completed. Then, the name-space managing section 41 notifies the data managing device 3 through the file-data transmitting/receiving section 40 that the processing to store the file data in a storage section has been completed. At the end of the processing described above, the processing to store the file data in the duplication eliminating storage device 4 is terminated.

### Processing to Read Out File Data Stored in the Duplication Eliminating Storage Device 4

Next, by referring to a flowchart shown in FIG. 6, the following description explains processing to read out file data stored in the duplication eliminating storage device 4. FIG. 6 is a flowchart representing typical processing to read out file data stored in the duplication eliminating storage device 4.

When a terminal transmits a read request including information specifying file data to the duplication eliminating storage device 4, at a step S301 of the flowchart shown in the figure, the file-data transmitting/receiving section 40 receives the request and forwards the request to the name-space managing section 41. An example of the information specifying file data is path-name information.

Then, at the next step S302, the name-space managing section 41 identifies an entry from the name-space management table typically on the basis of the path-name information. The identified entry is an entry for the file data specified by the read request as data to be read out from the duplication eliminating storage device 4. Then, the name-space managing section 41 extracts storage-destination address information of all post-division data, which is managed by associating the data with the identified entry, in the data storing section 45. Subsequently, the name-space managing section 41 outputs the extracted storage-destination address information and the read request to the data managing section 44.

Then, at the next step S303, the data managing section 44 reads out the data from the data storing section 45 on the basis of the storage-destination address information and outputs the data to the name-space managing section 41.

When the processing to read out all data associated with the entry recorded in the name-space management table to serve as the entry of the file data to be read out is ended, at the next step S304, the name-space managing section 41 determines whether or not the file data is data divided into block or object units. If the file data is found to be data divided into block or object units, the name-space managing section 41 outputs all data output by the data managing section 44 to the data dividing/synthesizing section 42. The data output by the data managing section 44 is pieces of post-division data.

Then, at the next step S305, the data dividing/synthesizing section 42 synthesizes the pieces of post-division data into the original single file data. Later on, the data dividing/synthesizing section 42 outputs the original single file data to the name-space managing section 41.

Then, at the next step S306, the name-space managing section 41 transmits the file data to the terminal, which has made the file-data read-out request, by way of the file-data transmitting/receiving section 40. The transmitted file data can be the file data obtained as a result of the synthesis or file data not divided into block or object units. The execution of the processing at this step ends the processing to read out file data.

So far, an exemplary embodiment of the present invention has been explained by referring to diagrams. However, concrete configurations of the present invention are by no means limited to the exemplary embodiment. That is to say, a variety of design changes or the like can be made within a range not deviating from essentials of the present invention.

The duplication eliminating storage device 4 has an internal computer system. The operations are carried out by the processing sections described above by the computer loading programs from a recording medium and executing the programs. The programs have been stored in the recording medium in a form that can be read by the computer. Examples of the recording medium that can be read by the computer include a magnetic disk, an opto-magnetic disk, a CD-ROM, a DVD-ROM and a semiconductor memory. As an alternative, the computer programs can be down-loaded to the computer through a communication line and the computer receiving the programs can then execute the programs.

In addition, the programs may implement some of the functions described above. On top of that, it is also possible to make use of the so-called difference program stored in the so-called difference file. The difference program is combined with a program already stored in the computer system in order to implement one of the functions described above.

As described above, the exemplary embodiment includes a duplication eliminating storage device provided with means for determining data duplications among a plurality of data units and means for determining a duplication elimination method making use of an optimum data unit for a file-data group stored in a file storage device. By carrying out processing of the means, it is possible to implement an operation to store data into the storage system while eliminating duplications as an operation desired by the user making use of the file storage device and adjusted to the trend of duplicated data generated by an application as well as the type of file data. That is to say, the data storage capacity of the duplication eliminating storage device is reduced and a data unit is determined dynamically instead of making use of a data unit determined in advance fixedly. Thus, it is possible to prevent the amount of extra management data for elimination of duplications from undesirably increasing due to elimination of duplications improper for the duplication generation trend. As a result, it is possible to reduce the data storage capacity to a value commensurate with the cost of the management for eliminating duplications.

As described above, the present invention provides a storage system for eliminating data storage inefficiencies exhibited by a duplication eliminating storage device due to the fact that a duplication generation trend based on a data utilization environment does not match the duplication determination unit. For example, the storage system is presumed to make use of file data included in a file-data group, which has been stored in a certain group of file storage device, to serve as an object to be saved for a long time period of time for the purpose of archiving.

The storage system according to the present invention is characterized in that the storage system includes:

data relocation destination determination means for acquiring data including a last access time and a last update time from metadata of file data stored in a file storage device group, for extracting a file group neither accessed nor updated for at least a predetermined period of time and for determining whether or not data stored in the file storage device is to be relocated to a duplication eliminating storage device;

data relocation processing means for carrying out data relocation processing on the basis of the determination performed by the data relocation destination determination means;

data-duplication-determination-unit determining means for acquiring file data stored in the file storage device group, for dividing the file data into data units such as file units, block units and group units if necessary, for determining whether or not there are data duplications among pieces of divided data, for computing a degree to which the data duplications can be detected for each of the data units and for determining an optimum data duplication determination unit for which the data can be divided in an optimum way and data duplications can be determined also in an optimum way; and
data relocation means for re-storing already stored data in optimum duplication determination units determined by the data-duplication-determination-unit determining means in case the data-duplication-determination-unit determining means changes the optimum data duplication determination unit.

In addition, the duplication eliminating storage device is characterized in that the duplication eliminating storage device includes:

duplication determining means for dividing file data to be stored into data division units such as file units, block units and group units by adoption of a data division method and for determining whether or not there are data division units included in the file data as units identical with data division units of already stored data; and

data-storage managing means for storing only a pointer pointing to a data division unit of already stored data if the duplication determining means determines that there is a data division unit included in the file data as a unit identical with the data division unit of already stored data.

It is to be noted that the division of file data into block units is an operation commenced from the start of the file data to divide the file data into blocks each having the same size determined in advance.

On the other hand, the division of file data into object units is an operation to divide the file data into objects such as text data and image data. An object of file data is an element which may be identical with a portion of another file.

Next, a minimum configuration of the storage system according to the present invention is explained. FIG. 7 is a block diagram depicting a typical minimum configuration of a storage system. As shown in the figure, the storage system includes duplication-determination-unit determining means 100 and duplication eliminating means 200 which each serve as a minimum-configuration element.

In the storage system having the minimum configuration shown in FIG. 7, the duplication-determination-unit determining means 100 divides data stored in a storage device into data division units and, on the basis of a duplication generation rate computed for each of the data division units, determines a duplication determination unit which is a unit used in determining duplications of the data. Then, on the basis of the duplication determination unit determined by the duplication-determination-unit determining means 100, the duplication eliminating means 200 carries out processing to eliminate duplications of data stored in the storage device.

Thus, according to the storage system having the minimum configuration, duplications of data are eliminated in accordance with a duplication generation trend. Accordingly, the data storage capacity can be reduced to a capacity commensurate with the cost of managing eliminations of data duplications without increasing the amount of management data used for elimination of unnecessary data duplications.

It is to be noted that the exemplary embodiment has characteristic configurations of a storage system described in paragraphs (1) to (5) as follows.
(1): A storage system is characterized in that the storage system includes:

duplication-determination-unit determining means (implemented typically by the data-duplication-determination-unit determining section 33) for determining a duplication determination unit, which is a unit to be used in determining duplications of data, on the basis of a duplication generation rate computed for each of a plurality of data division units (such as a file unit, a block unit or an object unit) obtained as a result of division of data stored in a storage device (such as the file storage device 1); and

duplication eliminating means (implemented typically by the data relocation processing section 34, the data dividing/synthesizing section 42, the data-duplication determining section 43 and the data managing section 44) for carrying out processing to eliminate duplications of the data stored in the storage device on the basis of the duplication determination unit determined by the duplication-determination-unit determining means.
(2): The storage system can have a configuration in which the duplication-determination-unit determining means determines a duplication determination unit on the basis of differences between the computed duplication generation rates.
(3): A storage system includes at least one file storage device (such as the file storage device 1) and a duplication eliminating storage device (such as the duplication eliminating storage device 2). The storage system is characterized in that the storage system includes:

data-division-unit determining means (implemented typically by the data-duplication-determination-unit determining section 33) for selectively determining one of a plurality of data division units by computing a duplication generation rate for each of the data division units and by comparing the duplication generation rates with each other when determining a duplication generation trend of data stored in the file storage device by making use of the data division units; and

data relocation means (implemented typically by the data relocation processing section 34, the data dividing/synthesizing section 42, the data-duplication determining section 43 and the data managing section 44) for relocating data from the file storage device to the duplication eliminating storage device in aforementioned data division units determined by the data-division-unit determining means.
(4): The storage system can have a configuration in which the duplication eliminating storage device includes duplication-elimination determining means (implemented typically by the data dividing/synthesizing section 42 and the data-duplication determining section 43) for dividing data into a plurality of aforementioned data division units and determining elimination of data duplications.
(5): The storage system can have a configuration in which the data-division-unit determining means determines a file unit, a block unit or an object unit as a data division unit where:

the file unit is a data division unit for an operation in which data is not divided;

the block unit is a data division unit obtained as a result of an operation commenced from the start of file data to divide the file data into blocks each having a data size determined in advance; and

the object unit is a data division unit obtained as a result of an operation to divide file data into objects each serving as an element which may be identical with a portion of another file.

The present invention has been described above by explaining an exemplary embodiment and implementations. However, realizations of the present invention are by no means limited to the exemplary embodiment and implementations. That is to say, it is possible to change the configuration of the present invention and details of the present invention in a variety of ways, which can be understood by persons skilled in the art, provided that the changes are within the scope of the present invention.

The present invention contains a subject matter related to Japanese Patent Application JP 2010-234807 filed in the Japanese Patent Office on Oct. 19, 2010, the entire contents of which are incorporated herein by reference.

### INDUSTRIAL APPLICABILITY

The present invention can be applied to applications for reducing the physical recording capacity of a storage device for concentratively storing data.

### REFERENCE SIGNS LIST

1 . . . File storage device
2 . . . Network
3 . . . Data managing device
4 . . . Duplication eliminating storage device
30 . . . File-data transmitting/receiving section
31 . . . Metadata managing section
32 . . . Data-location-destination determining section
33 . . . Data-duplication-determination-unit determining section
34 . . . Data relocation processing section
40 . . . File-data transmitting/receiving section
41 . . . Name-space managing section
42 . . . Data dividing/synthesizing section
43 . . . Data-duplication determining section
44 . . . Data managing section
45 . . . Data storing section
100 . . . Duplication-determination-unit determining means
200 . . . Duplication eliminating means

What is claimed is:

1. A storage system comprising:
a duplication-determination-unit determining section for determining a duplication determination unit, which is a unit to be used in determining duplications of data, on the basis of a duplication generation rate computed for each of a plurality of data division units obtained as a result of division of data stored in a storage device; and
a duplication eliminating section for carrying out processing to eliminate duplications of said data stored in said storage device on the basis of said duplication determination unit determined by said duplication-determination-unit determining section.

2. The storage system according to claim 1 wherein said duplication-determination-unit determining section determines a duplication determination unit on the basis of differences between said computed duplication generation rates.

3. A storage system comprising
at least one file storage device, and
a duplication eliminating storage device, said storage system including:
a data-division-unit determining section for selectively determining one of a plurality of data division units by computing a duplication generation rate for each of said data division units and by comparing said duplication generation rates with each other when determining a duplication generation trend of data stored in said file storage device by making use of said data division units; and
a data relocation section for relocating data from said file storage device to said duplication eliminating storage device in said data division units determined by said data-division-unit determining section.

4. The storage system according to claim 3 wherein said duplication eliminating storage device includes a duplication-elimination determining section for dividing data into a plurality of said data division units and determining elimination of data duplications.

5. The storage system according to claim 3 wherein said data-division-unit determining section determines said data division unit by selecting one of a file unit, a block unit and an object unit,
said file unit being a data division unit for an operation in which data is not divided;
said block unit being a data division unit obtained as a result of an operation commenced from the start of file data to divide said file data into blocks each having a data size determined in advance; and
said object unit being a data division unit obtained as a result of an operation to divide file data into objects each serving as an element that may be identical with a portion of another file.

6. A data management device comprising:
a duplication-determination-unit determining section for determining a duplication determination unit, which is a unit to be used in determining duplications of data, on the basis of a duplication generation rate computed for each of a plurality of data division units obtained as a result of division of data stored in a storage device; and
a duplication eliminating section for carrying out processing to eliminate duplications of said data stored in said storage device on the basis of said duplication determination unit determined by said duplication-determination-unit determining section.

7. A data management method comprising the steps of:
determining a duplication determination unit, which is a unit to be used in determining duplications of data, on the basis of a duplication generation rate computed for each of a plurality of data division units obtained as a result of division of data stored in a storage device; and
carrying out processing to eliminate duplications of said data stored in said storage device on the basis of said determined duplication determination unit.

8. A computer readable information recording medium storing a data management program to be executed by a computer to carry out:
duplication-determination-unit determination processing of determining a duplication determination unit, which is a unit to be used in determining duplications of data, on the basis of a duplication generation rate computed for each of a plurality of data division units obtained as a result of division of data stored in a storage device; and
duplication elimination processing of eliminating duplications of said data stored in said storage device on the basis of said determined duplication determination unit.
